(19) United States
(12) Patent Application Publication
(10) Pub. No.: US 2018/0026259 A1
(43) Pub. Date: Jan. 25, 2018

(54) Mixed Redox Couple Electrodes for Rate Capability and Overdischarge Protection

(71) Applicants: University of Florida Research Foundation, Inc., Gainesville, FL (US); G4 Synergetics, Inc., Alachua, FL (US)

(72) Inventors: Kevin William Powers, Gainesville, FL (US); Michael D. Kellar, Gainesville, FL (US); Jon K. West, Gainesville, FL (US); Julius O. Regalado, Gainesville, FL (US)

(21) Appl. No.: 15/545,882

(22) PCT Filed: Jan. 22, 2016
(86) PCT No.: PCT/US16/14425

§ 371 Date: Jul. 24, 2017

Related U.S. Application Data
(60) Provisional application No. 62/106,444, filed on Jan. 22, 2015.
(60) Provisional application No. 62/109,801, filed on Jan. 30, 2015.

(51) Int. Cl. H01M 4/36; H01M 4/505; H01M 10/0525; H01M 4/58

(52) U.S. Cl. CPC H01M 4/364; H01M 4/5825; H01M 4/505; H01M 10/0525; H01M 2004/028

(57) ABSTRACT

A composite electrode is a composite of conductive materials of at least a first material and a second material, wherein the first material undergoes a parasitic reaction in a region where the second material is stable, and the first material and second material are stable at the first material's nominal voltage. An exemplary electrode is a cathode comprising lithium manganese oxide (LMO) and lithium iron phosphate (LFP).

### CROSS-REFERENCE TO RELATED APPLICATIONS

This application claims the benefit of U.S. Provisional Application Ser. No. 62/106,444, filed Jan. 22, 2015 and U.S. Provisional Application Ser. No. 62/109,801, filed Jan. 30, 2015, the disclosures of which are hereby incorporated by reference in their entireties, including all figures, tables and drawings.

### BACKGROUND OF INVENTION

A typical battery electrode does not see uniform currents. Much research has focused on how or why this problem occurs, but very little disclosure suggests its solutions. Lithium ion batteries have impacted consumer electronics and potentially can revolutionize transportation. Although introduced two decades ago, charge distribution within battery electrodes remains poorly understood and uncontrollable. Non-unifoiiii charge distribution within battery electrodes is believed to impact performance in a variety of ways, including reduced energy and power, underutilization of capacity, localized heat generation, and overcharge or over-discharge. While several current distribution models have been developed, experimental data on composite electrodes such as those used in lithium-ion batteries has lagged. Liu et al. J. Phys. Chem. Lett. 2010, 1, 14, 2120-2123, provided a method for direct determination and visualization of the distribution of charge in a composite electrode using synchrotron x-ray micro-diffraction to determine a state-of-charge profiles in-plane and normal to the current collector. Recently in situ and operando soft X-ray absorption spectroscopy has been demonstrated, Liu et al, Nature Communications 2013, 4, 2568.

However, the design of an electrode with uniform charge density remains elusive. To this goal, a battery electrode with uniform current is pursed where the current distribution is artificially evened out in an electrode by using a plurality of active materials with different nominal voltages.

### BRIEF SUMMARY

Embodiments of the invention are directed to a composite electrode where a composite of at least a first material and a second material, and the first material and second material are stable at the first material's nominal voltage and the second material's nominal voltage is higher than that of the first material. The first material undergoes a parasitic reaction in a region where the second material is stable. In an exemplary embodiment the electrode is a cathode comprising lithium iron phosphate (LFP) as the first material and lithium manganese oxide (LMO) as the second material. The first material and the second material reside at different proportions in different portions of the electrode to promote uniform current distribution. In embodiments of the invention, batteries employ one or more composite electrodes as disclosed above in one or more cells of a battery.

### BRIEF DESCRIPTION OF DRAWINGS

FIG. 1 is an image of a disassembled battery electrode that shows heterogeneities in the current distribution.

FIG. 2 shows a plot of the charge/discharge voltage profile of a distributed mixed redox couple electrode cell, according to an embodiment of the invention.

FIG. 3 shows a plot of the charge/discharge voltage profile of a uniform mixed electrode, according to an embodiment of the invention.

FIG. 4 shows a plot of the charge/discharge voltage profile of a LFP electrode.

FIG. 5 shows a plot of the charge/discharge voltage profile of a LMO electrode.

FIG. 6 shows XRD patterns of middle (top) and edge of C/2 discharged masked LFP electrode.

FIG. 7 is a plot of the percent capacity discharge for various discharge rates using a masked single component LFP electrode, control cell, and a masked MRC electrode.

FIG. 8 shows the C/20 charging curves following various discharge rates for MRC electrodes, according to an embodiment of the invention, following discharging, from left to right, of C/5, C/2, and C.

FIG. 9 presents the data of FIG. 8 where the LMO voltage plateaus are overlapped to display their similarity at roughly 4.2V.

### DETAILED DISCLOSURE

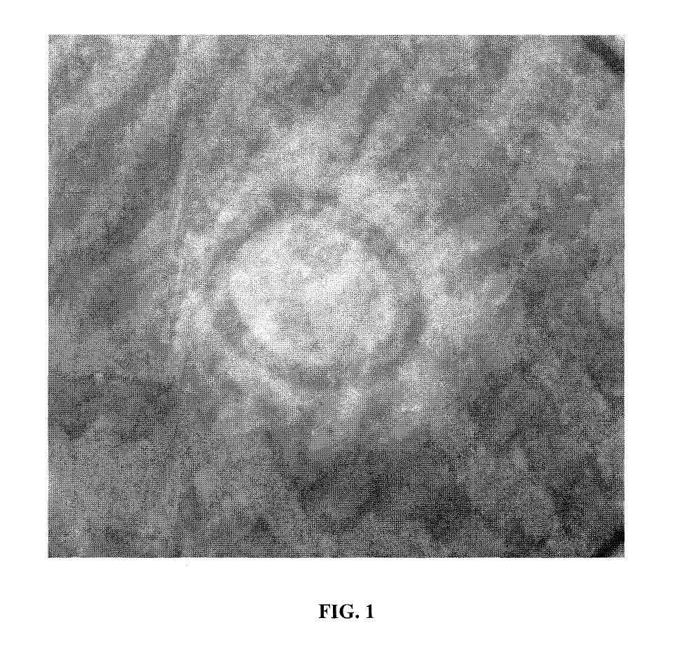

According to an embodiment of the invention, a combination of Li-ion battery chemistries is incorporated concurrently in a single positive Li-ion electrode (cathode). The combination of chemistries produces multiple electrochemical couples at different selected potentials. Any duplet of cathode materials, where a first material undergoes a parasitic reaction in a region where the second material is stable, and both materials are stable at the first material's nominal voltage, can be used. For lithium-ion technology, there is a plethora of electrode material available. Focusing on the positive electrode (cathode) during discharge, a common limiting scenario for high-power applications, referred to as lithiation, is that lithium ions are reinserted into the electrode. As the magnitude of current increases, portions of the electrode become harder to access. As shown in FIG. 1 for a Ni(OH)₂ electrode, the positive electrode in a NiMH battery changes color depending on its oxidative state. This results in color striations signifying a varying current distribution across the electrode's surface. The dark black halo corresponds to the most active region, followed by the less dark regions outside of the halo. The inner lighter region signifies the least contribution to the total current, and the inner “green” halo is likely not being accessed, as it maintains the color of the pristine material. According to an embodiment of the invention, by placing higher voltage material in the poorly participating portions of the electrode, current is biased artificially to these portions of the electrode that would otherwise not be accessed. The higher voltage material can bias current to itself. As such, a mixed redox electrode that will outperform a single redox electrode can be constructed. Common materials that can be combined into a composite electrode are, for example, but not limited to, lithium manganese oxide (LMO) and lithium iron phosphate (LFP). Other Li cathodes, for example, LiCoO₂, LiNi_{0. 8}Co_{0.15}Al_{0.05}O₂, or LiNi_{1/3}Mn_{1/3}Co_{1/3}O₂, can be used as components of the composite cathode. In another embodiment of the invention, a mixed redox couple electrode allows abuse protection.

LMO is structurally stable at the nominal voltage of LFP (3.45 V), but LMO exhibits instability in a region of stability for LFP's voltage (<3.1 V). Over-discharge and over-charge are common problems for multi-cell batteries, which constitute most commercial batteries, because it is difficult to accurately measure and respond to individual cells that may have lost capacity, and whose voltage begins to move outside of the cell's stability range. For LMO, the cell can be inadvertently over-discharged with irrevocable damage. By including a small amount of LFP, which has a stable and flat voltage plateau between the nominal voltage of LMO and the potential that begins to cause a deleterious reaction, the electrode has an over-discharge buffer. This over-discharge buffer provides a greater safety margin for LMO electrodes and a more evident diagnostic that a cell is nearing over-discharge. Alternatives to the composite electrodes, according to an embodiment of the invention, are advanced battery-management-systems, which can add a great deal of cost and weight to a battery pack, and non-active additives, which allow sacrificial reactions, have significant shortcomings. The sacrificial additives do not provide any reversible capacity and often their reaction products are not desirable.

Although exemplary cathodes include LMO and LFP, any combination of lithium-ion cathode materials can be used as long as the materials are compatible with the battery's electrolyte. The composite cathode increases the battery's performance at high discharge rates (high power applications) and extends the cycle life of the battery with no penalty in cell capacity. It can also be used specifically with the lithium manganese oxide/lithium iron phosphate composite to provide over discharge protection to lithium manganese oxide.

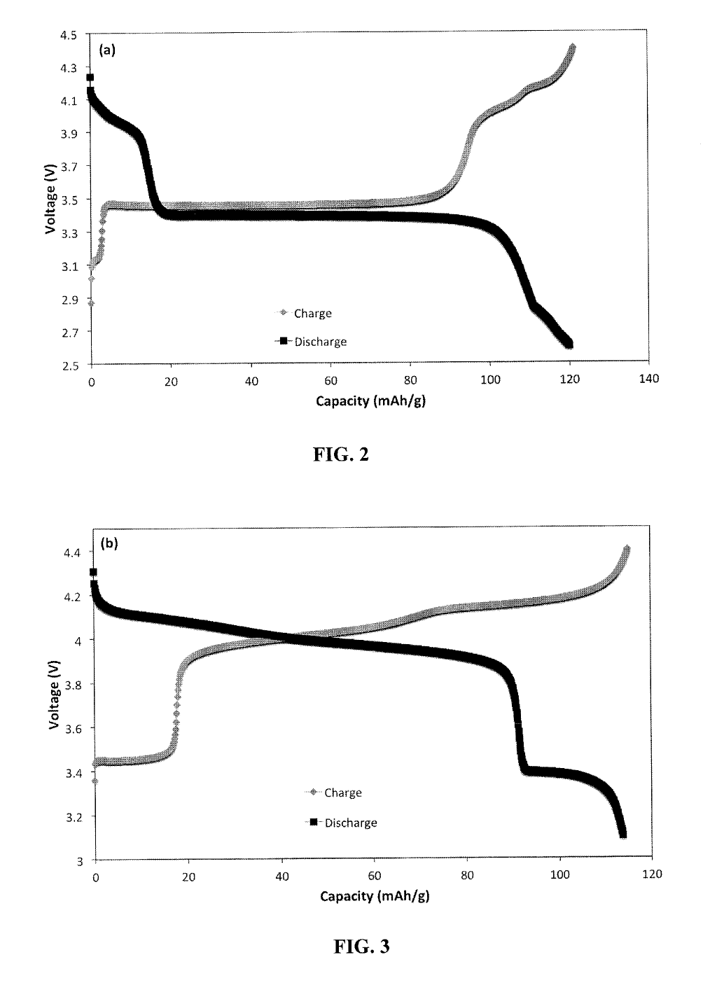

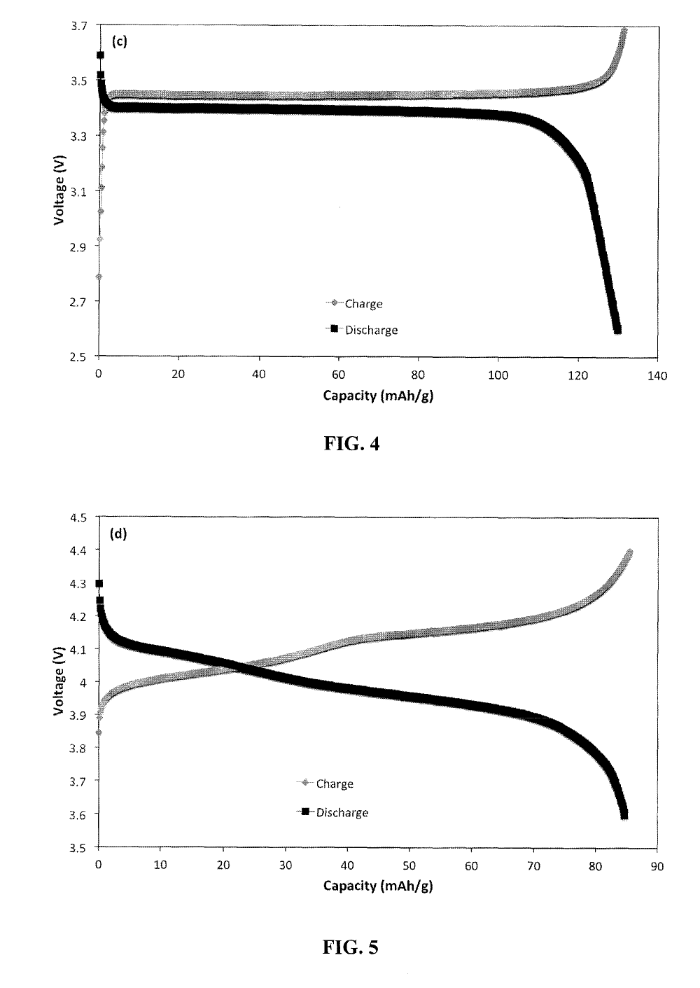

For electrodes according to embodiments of the invention, C/10 cycling tests show stability due to the inclusion of multiple active materials in the same electrode. FIG. 2 shows a voltage curve showing the charge-discharge profile for a mixed-redox couple (MRC) electrode with a middle disk having a 4:1 ratio of LMO:LFP and the outer ring having only LFP as an active material. FIG. 3 shows a voltage curve from an electrode with identical composition of mixed active materials for the inner disk of the MRC electrode and the outer ring also being a uniform mixture of the 4:1 ratio of LMO:LFP. As the theoretical capacity for LFP is 170 mAh/g and for LMO is 148 mAh/g, the uniform mixed electrode has a theoretical capacity of 152 mAh/g. The capacity of the mixed electrode is taken as the mass average of the two individual materials. FIG. 4 and FIG. 5 show voltage curves for LFP and LMO electrodes, respectively. The voltage of the MRC electrode is a superposition of the two separate voltages: the lower voltage will fully charge first and the higher voltage will discharge first. However, as the curves in FIG. 2 are representative of C/10 constant current cycles and not GITT measurements, they are not completely representative of open circuit conditions. The LMO portions of the MRC electrodes appear to charge more than discharge, as indicated in FIGS. 2 and 3, because not all of the LFP is equally readily charged, and so the LMO particles can short-circuit these regions as the LMO particles begin to delithiate. The incurred voltage penalty is characteristic of the ability of the electrode to access the regions of higher resistance as the higher voltage LMO sites provide a thermodynamic driving force to overcome the ohmic energy barrier.

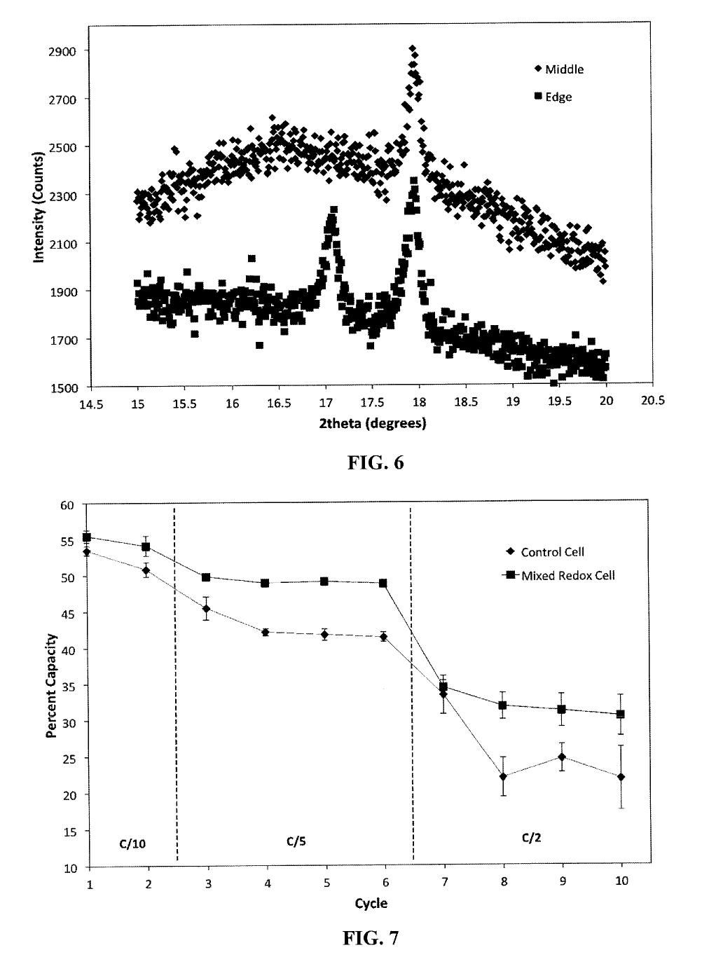

Discharge performance is of primary importance as pertaining to lithiation of the positive electrode. To assure attainment of a desired and reproducible starting current distribution in the electrolyte, a polyethylene disk is placed over the middle of the electrode as a mask, elongating the ionic path to reach that portion and substantially raising the series resistance to that specific region. XRD patterns are taken of the middle and edge of a masked LFP electrode to verify the efficacy of the mask to deter current from the middle of the electrode due to the added series resistance, as shown in FIG. 6. LFP exhibits a well-characterized peak shift as it lithiates/delithiates, owing to a slight expansion of the lattice. Because of the immiscibility of the charged and discharged phases, the shift is observed as a shrinking of one peak and a growing of the other rather than a positional change of a single peak. This feature allows the identification of the middle as being in a fully charged state while the edge is in a partially discharged state. The cell had been charged at a C/20 rate, and subsequently discharged at C/2. As the middle appears not to have been lithiated on the discharge, it can be concluded that utilizing the polymer mask substantially increases series resistance of the middle of the electrode, and that the LFP residing in the middle is not accessed. This can be taken as an extreme case for an industrial cell. Additionally, this result indicates the potential of holding a porous electrode at different states of charge.

Because of the different theoretical capacity of the LFP and mixed electrodes, percent theoretical capacity is the chosen figure of merit to properly compare the utility of the two different electrode formulations. FIG. 7 displays the percent theoretical capacity discharged at varying rates for a single-component LFP cell, labeled control cell, and an MRC electrode, mixed redox cell. Both electrodes have a mask over their middle to hinder current in the electrolyte from reaching that region. The MRC cell clearly outperforms the single-component cell. From FIGS. 4 and 5, it is evident that commercial LFP outperforms commercial LMO in terms of percent capacity. If one assumes no synergistic effect between the two materials, the percent capacity should go down as LMO is added into the electrode. However, the reverse occurs, strongly suggesting a synergistic benefit of utilizing the two materials of different nominal voltages in different regions of the electrode.

As FIG. 6 indicates, the addition of the mask hinders current flow to the center of the electrode. By adding a material with a more positive standard reduction potential to this region, LMO, current is biased to that less accessible region. The reason can be seen in terms of the series resistance voltage drop. Because current path to the center is longer and more tortuous, the electrolyte resistance rises, and the current to that region drops. However, as the voltage in the ionically hindered area rises, becoming preferred to lithium ions and electrons, the voltage drops from a higher initial voltage in that region. Therefore, the less favored region due to its smaller potential driving force becomes counteracted by making that region initially more favorable. The variable electrode design allows adaption of intrinsic limitations that are imposed by other design criteria.

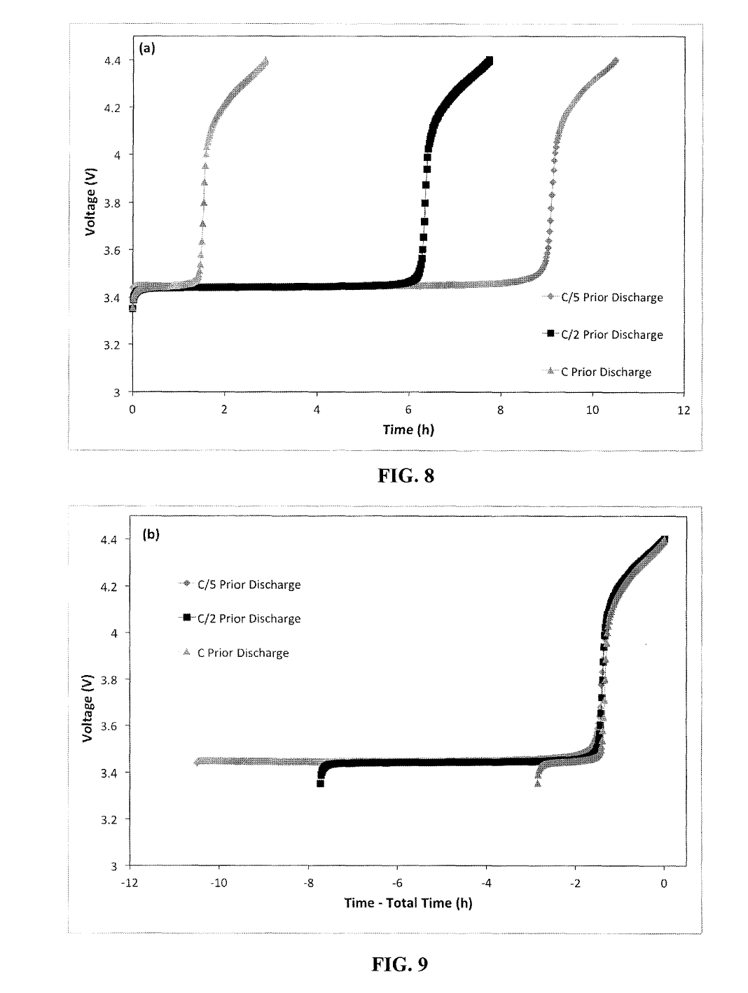

Further evidence for these electrodes' efficiency can be displayed in analysis of the MRC charging curves. FIG. 8 shows subsequent C/20 charges after varying discharge rates. As the charge cycle of a positive electrode corresponds to delithiation, with charging carried out at a much lower current than discharges, the charging curves give a sense of the amount of delithiation on the preceding discharge. FIG. 8 shows conventionally graphed charging curves following discharges at C/5, C/2, and C rates. It is apparent that the LFP is drastically different when the cell has been previously discharged, judging from the lengths of the charge plateaus at the nominal voltage for LFP, roughly 3.45V. FIG. 9 shows the same discharge curves graphed as an affine transformation in order to compare the lengths of the LMO voltage plateaus, at a nominal voltage of roughly 4.2V. As indicated in FIG. 9, the lengths of the LMO voltage plateaus at roughly 4.2V are virtually identical, suggesting that the amount of the LMO reacted is independent of the discharge rate.

These results display the effect of the design of an LIB electrode, according to embodiments of the invention, where multiple materials of different redox couples are used to artificially bias current. The design is beneficial for batteries, cells, or electrodes where a non-uniform current distribution, such as from different ionic or electronic conductivities in the electrode or from different electrolyte conductivities, result in geometrically induced current distributions. By blocking a portion of the positive electrode to the bulk electrolyte, the region displays an increase in series resistance and a substantial drop in use. By including within that region a second active material having a more positive reduction potential for lithium ions, a restored utility of that region occurs. For large-scale industrial batteries, which can build up large current distributions, this design provides greater capacity for the batteries at higher rates. Though LFP and LMO were chosen as materials in this work, the concept is ubiquitous when both materials are stable at the other's redox plateau. The ubiquitous nature of this work should be seen as a great advantage, as it minimizes the barrier for commercialization.

All publications referred to or cited herein are incorporated by reference in their entirety, including all figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application.

We claim:

1. A composite electrode, comprising a composite of at least a first material and a second material, wherein the first material and the second material are stable at the first material's nominal voltage and the second material's nominal voltage is higher than that of the first material.

2. The composite electrode according to claim 1, wherein the electrode is a cathode comprising lithium manganese oxide (LMO) as the first material and lithium iron phosphate (LFP) as the second material.

3. The composite electrode according to claim 1, wherein the first material and the second material are at different proportions at different portions of the electrode to promote uniform current distribution, and wherein the second material is a majority in the portions of the electrode that would be poorly participating if constructed of a single material.

4. The composite electrode according to claim 1, wherein the first material undergoes a parasitic reaction in a region where the second material is stable.

5. A battery comprising one or more composite according to claim 1 in one or more cells of the battery.
